(19) United States
(12) Patent Application Publication
(10) Pub. No.: US 2014/0168183 A1
(43) Pub. Date: Jun. 19, 2014

(54) DRIVING DEVICE FOR CONTROLLING POLARITY REVERSAL OF LIQUID CRYSTAL DISPLAY PANEL

(71) Applicant: Xueliang Yang, Shenzhen City (CN)

(72) Inventor: Xueliang Yang, Shenzhen City (CN)

(73) Assignee: Shenzhen China Star Optoelectronics Technology Co Ltd., Shenzhen, Guangdong (CN)

(21) Appl. No.: 13/810,929

(22) PCT Filed: Dec. 24, 2012
(86) PCT No.: PCT/CN2012/087252

§ 371 Date: Jan. 18, 2013

(30) Foreign Application Priority Data
Dec. 14, 2012 (CN) 201210540546.7

(51) Int. Cl. G09G 3/36

(52) U.S. Cl. CPC G09G 3/3614
USPC 345/209; 345/87

(57) ABSTRACT

The present invention provides a driving device for controlling polarity reversal for liquid crystal display panel, which includes a timing control circuit, for adding a polarity reversal control bit to image data, and generating image data of mini-LVDS format according to predefined mini-LVDS format protocol; and a panel driving circuit, for receiving image data of the control information of mini-LVDS format from the timing control circuit, and separating the polarity reversal control bit and the image data of the pixels from the received image data of mini-LVDS format.

### BACKGROUND OF THE INVENTION

1. Field of the Invention

The present invention relates to the field of a driving device for liquid crystal display (LCD) panel, and in particular to a driving device for controlling polarity reversal of LCD panel.

2. The Related Arts

The liquid crystal displaying techniques is based on applying voltage to liquid crystal molecules to rotate the molecules to specific angles to accomplish displaying. By changing the driving voltage applied to the two ends of the liquid crystal molecules so rotate the liquid crystal molecules correspondingly, the direction of travel of the light generated by the backlight unit will change so as to display different grayscale luminance through various combinations of the liquid crystal molecules at different rotation angles at the red, green and blue filters above the liquid crystal layer. By various combinations of red, green and blue sub-pixels with different grayscale luminance, a single pixel having different colors can be displayed.

A characteristic of the liquid crystal molecules is that when the driving voltage applied to the liquid crystal molecules remains the same polarity, the liquid crystal molecules will be damaged and unable to recover. Therefore, the polarity of the driving voltage must be reversed periodically while maintaining the same voltage level on the two ends of the liquid crystal molecules. In other words, the positive voltage polarity and the negative voltage polarity of the driving voltage with respect to the common electrode are exchanged. The positive/negative polarity of the driving voltage is relative to the common electrode of the LCD panel. When the voltage of the pixel electrode is at a higher level than the voltage of the common electrode, the voltage is called a positive polarity. On the other hand, when the voltage of the pixel electrode is at a lower level than the voltage of the common electrode, the voltage is called a negative polarity. Regardless of the positive/negative of the voltage of the pixel electrode, the same grayscale luminance will be display for voltages with the same absolute value. Therefore, when the absolute value of the voltage difference between the pixel electrode voltage and the common voltage is fixed, the pixel will display the same grayscale luminance whether the polarity of voltage of the pixel electrode is positive or negative, but the liquid crystal molecules have the different rotation direction. As such, the potential damage caused by the liquid crystal molecules maintaining the same direction is avoided.

The known technique is to provide a polarity control signal POL to the driving circuit, and the driving circuit controls the polarity reversal of the voltage of the pixel electrode according to an internal defined manner. However, the number of the known POL signal is limited and the polarity reversal manner is more monotonic, which leads to flicker or crosstalk phenomena.

### SUMMARY OF THE INVENTION

The present invention provides device and method for controlling the polarity reversal of the pixel of the LCD panel by using a mini-low voltage differential signal (mini-LVDS) in a driving device of the LCD panel.

The driving device for controlling polarity reversal of LCD panel comprises: a timing control circuit, for adding a polarity reversal control bit to image data, and generating image data of mini-LVDS format according to predefined mini-LVDS format protocol; and a panel driving circuit, for receiving image data of the control information of mini-LVDS format from the timing control circuit, and separating the polarity reversal control bit and the image data of the pixels from the received image data of mini-LVDS format.

According to a preferred embodiment of the present invention, the timing control circuit comprises: a polarity reversal control information processing unit, having registers and polarity reversal control information table; and a mini-LVDS transmission unit, for generating and transmitting image data of mini-LVDS format; wherein the polarity reversal control information processing unit temporarily stores the image data in the register, based on the polarity reversal control information table, add data bit corresponding to the polarity reversal control information of each pixel of the LCD panel to the image data temporarily stored in the register, and outputs the image data added with polarity reversal control information to the mini-LVDS transmission unit.

According to a preferred embodiment of the present invention, the panel driving circuit comprises: a mini-LVDS receiving unit, which further comprises a decoder, the decoder decodes the received image data of mini-LVDS format according to predefined mini-LVDS format protocol to obtain polarity reversal control bit, and uses remaining bits of the image data of the mini-LVDS format as image data of the pixel.

According to a preferred embodiment of the present invention, the predefined mini-LVDS format protocol expands the original N-bit image data to N+1 bits.

According to a preferred embodiment of the present invention, the polarity reversal control bit is added to a bit position in front of the N-bit image data.

The device and method includes the polarity control signal POL in the image data of mini-LVDS format, which not only precisely controls the voltage polarity of each pixel, but can also edit the polarity in the image to optimize the image to as to improve the known problems, such as, flicker, crosstalk and H block, in the LCD panel.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a block diagram showing the structure of a driving device for LCD panel according to the present invention;

FIG. 2 is a schematic view of a known mini-LVDS data format;

FIG. 3 is a schematic view showing the structure of a timing control circuit TCON 110 of the driving device of the LCD panel according to the present invention;

FIG. 4 is a schematic view showing the mini-LVDS data format for controlling the polarity reversal of the pixels of the LCD panel according to the present invention; and

FIG. 5 is a schematic view showing the structure of the panel driving circuit of the driving device of LCD panel according to the present invention.

### DETAILED DESCRIPTION OF THE PREFERRED EMBODIMENTS

The following provides a clear and complete description of the technical solution according to the present invention using the drawing and the embodiment. Apparently, the drawings described below show only example embodiments of the present invention, instead of all embodiments. For other embodiments based on the disclosed drawings and embodiments, and obtained by those having ordinary skills in the art without paying any creative effort are also within the scope of the present invention. In addition, for clarity and briefness, the descriptions of common known functions and structures are omitted.

It should be understood that the terminology used in the description and claims are not restricted to the textual meaning, and is only for illustrative purpose, instead of restrictive purpose.

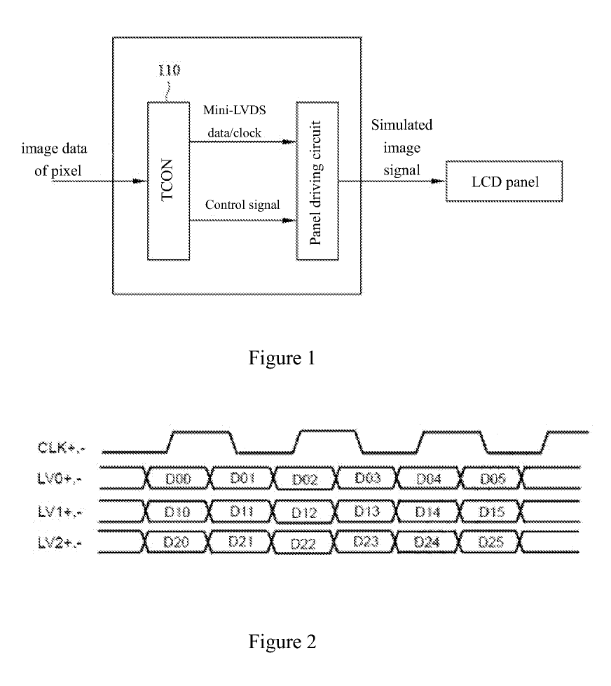

Referring to FIG. 1, is a block diagram showing the structure of a driving device 100 for LCD panel according to the present invention.

As shown in FIG. 1, the driving device 100 of LCD panel comprises: a timing control circuit (TCON) 110 and a panel driving circuit 120. The timing control circuit 110 is for receiving image data signal of the screen, generating image data signal of mini-LVDS format, clock signal and control signal, and transmitting the generated image data signal of mini-LVDS format, clock signal and control signal to the panel driving circuit 120. In the instant embodiment, the timing control circuit 110 adds a polarity reversal control bit corresponding to the POL signal to image data signal to form new image data with the original image data added with polarity reversal control information bit. The panel driving circuit 120 receives the image data signal of mini-LVDS format transmitted by TCON 110, and separates the polarity reversal control signal POL and the image data signal for LCD panel from the new image data signal.

FIG. 2 is a schematic view of a known mini-LVDS data format. As shown in FIG. 2, the image data of the mini-LVDS signal of a known LCD panel only comprises the image data of the pixel data of the LCD panel, i.e., D00, D01, . . . , D25. In known mini-LVDS signal, the rising edge and the falling edge of the clock signal CLK latches the data.

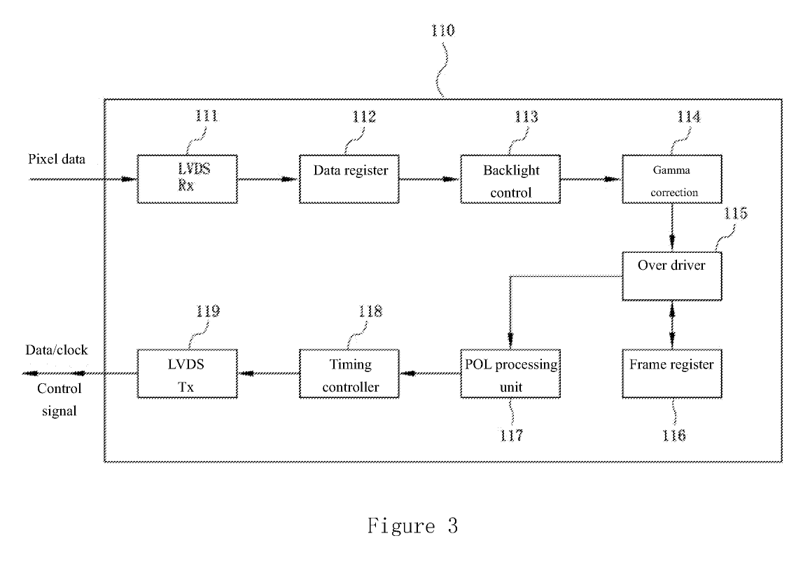

FIG. 3 is a schematic view showing the structure of a timing control circuit TCON 110 of the driving device of the LCD panel according to the present invention. As shown in FIG. 3, the TCON 110 of the present invention comprises an LVDS receiver 111, a data latch 112, a backlight control unit 113, a Gamma correction unit 114, an over driver 115, a frame memory 116, a polarity signal POL information processing unit 117, a timing controller 118 and a mini-LVDS transmitter 119, wherein the functions and operations of the LVDS receiver 111, data latch 112, backlight control unit 113, Gamma correction unit 114, over driver 115, frame memory 116, timing controller 118 and mini-LVDS transmitter 119 are similar to those in known technique, and the detailed descriptions are omitted here. The following describes the polarity signal POL information processing unit 117 of the TCON 110 in details.

When the polarity signal POL information processing unit 117 receives image data signal from the over driver 116, the polarity signal POL information processing unit 117 temporarily stores the image data signal into a register. The polarity signal POL information processing unit 117 also maintains a polarity reversal information table. The polarity reversal information table records the information for polarity reversal control signal of each pixel of the LCD panel. The polarity signal POL information processing unit 117 adds a data bit corresponding to the polarity reversal control information of each pixel to the image data signal temporarily stored in the register, and outputs the image data added with polarity reversal control information so as to expand the N-bit image data to (N+1)-bit image data.

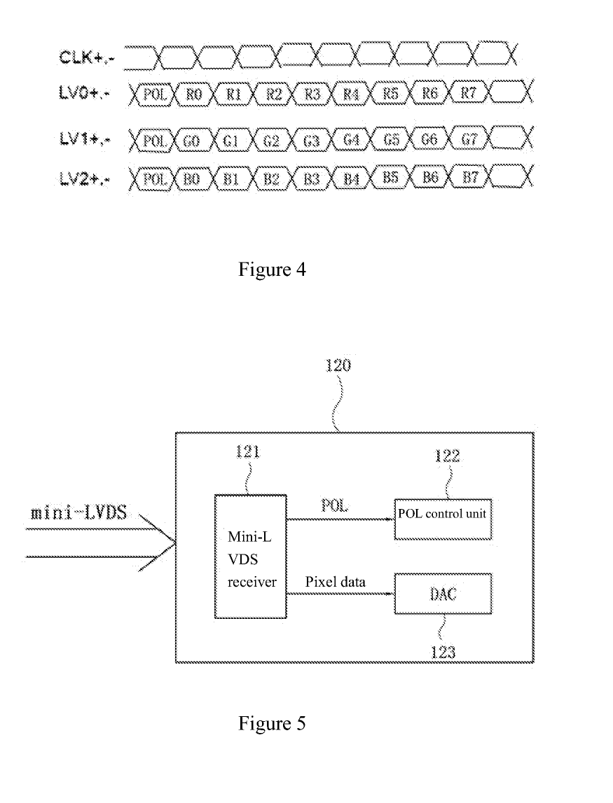

FIG. 4 is a schematic view showing the mini-LVDS data format for controlling the polarity reversal of the pixels of the LCD panel according to the present invention.

As shown in FIG. 4, compared to the known mini-LVDS data format shown in FIG. 2, a POL information bit is added to the first bit in the image data signal of mini-LVDS format for the R, G, B sub-pixels. FIG. 4 shows a scenario wherein the image data of the sub-pixel is 8 bits, i.e., when N=8. This is also applicable to image data of other length. Without changing the mini-LVDS protocol, a bit is added on the basis of the original protocol.

FIG. 5 is a schematic view showing the structure of the panel driving circuit 120 of the driving device of LCD panel according to the present invention. As shown in FIG. 5, the panel driving circuit 120 comprises a mini-LVDS receiver 121, a polarity reversal control unit 122 and a digital-to-analog converter (DAC) 123. It should be noted that the panel driving circuit may further comprises other elements to realize functions in known technique.

When the panel driving circuit 120 receives mini-LVDS signal from the TCON 110, the mini-LVDS receiver 121 decodes the image data signal to obtain the POL signal according to the predefined protocol. For example, when using the data format shown in FIG. 4, the mini-LVDS 121 may further comprise a decoder. The decoder decodes the first bit of the image data signal as the POL signal, and the remaining bits of the image data signal as the image data signal. The POL signal obtained from the mini-LVDS receiver is transmitted to the polarity reversal control unit 122 for controlling the polarity reversal of the pixels. The remaining bits as the image data signal are transmitted to DAC 123 for use as data image.

In summary, by changing the mini-LVDS data format in known technique, the present invention can add POL signal to the original image data, which increases the POL signal mode and edible POL signal mode. By precisely controlling the voltage polarity of each pixel, the flicker and crosstalk problem can be avoided.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A driving device for controlling polarity reversal of LCD panel, which comprises:
a timing control circuit, for adding a polarity reversal control bit to image data, and generating image data of mini-LVDS format according to predefined mini-LVDS format protocol; and
a panel driving circuit, for receiving image data of the control information of mini-LVDS format from the timing control circuit, and separating the polarity reversal control bit and the image data of the pixels from the received image data of mini-LVDS format.

2. The driving device as claimed in claim 1, wherein the timing control circuit comprises:
a polarity reversal control information processing unit, having registers and polarity reversal control information table; and
a mini-LVDS transmission unit, for generating and transmitting image data of mini-LVDS format;
wherein the polarity reversal control information processing unit temporarily stores the image data in the register, based on the polarity reversal control information table, add data bit corresponding to the polarity reversal control information of each pixel of the LCD panel to the image data temporarily stored in the register, and outputs the image data added with polarity reversal control information to the mini-LVDS transmission unit.

3. The driving device as claimed in claim 1, wherein the panel driving circuit comprises:
a mini-LVDS receiving unit, which further comprises a decoder, the decoder decodes the received image data of mini-LVDS format according to predefined mini-LVDS format protocol to obtain polarity reversal control bit, and uses remaining bits of the image data of the mini-LVDS format as image data of the pixel.

4. The driving device as claimed in claim 1, wherein the predefined mini-LVDS format protocol expands the original N-bit image data to N+1 bits.

5. The driving device as claimed in claim 2, wherein the predefined mini-LVDS format protocol expands the original N-bit image data to N+1 bits.

6. The driving device as claimed in claim 3, wherein the polarity reversal control bit is added to a bit position in front of the N-bit image data.

7. The driving device as claimed in claim 4, wherein the polarity reversal control bit is added to a bit position in front of the N-bit image data.

8. The driving device as claimed in claim 5, wherein the polarity reversal control bit is added to a bit position in front of the N-bit image data.

9. The driving device as claimed in claim 6, wherein the polarity reversal control bit is added to a bit position in front of the N-bit image data.
